(19) United States
(12) Patent Application Publication
(10) Pub. No.: US 2010/0103062 A1
(43) Pub. Date: Apr. 29, 2010

(54) Slot Antenna

(76) Inventors: Wei-Shan Chang, Taipei Hsien (TW); Chia-Tien Li, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/548,441

(22) Filed: Aug. 27, 2009

(30) Foreign Application Priority Data
Oct. 28, 2008 (TW) 097141335

(51) Int. Cl. H01Q 13/10

(52) U.S. Cl. 343/767

(57) ABSTRACT

A slot antenna includes a substrate, a radiator, a signal-feeding segment, a signal-feeding end, a first extension section and a second extension section. The substrate includes a first plane and a second plane. The radiator is set on the first plane of the substrate, and includes a slot. The signal-feeding segment is set in a position on the second plane of the substrate corresponding to the slot. The signal-feeding end is electrically connected to the signal-feeding segment, and is utilized for transmitting signals. The first extension section is set on a first side of the signal-feeding segment on the second plane of the substrate, and is utilized for increasing a bandwidth of the slot antenna. The second extension section is set on a second side of the signal-feeding segment on the second plane of the substrate, and is utilized for increasing the bandwidth of the slot antenna.

### BACKGROUND OF THE INVENTION

1. Field of the Invention

The present invention relates to a slot antenna, and more particularly, to a slot antenna for reducing an area, and increasing a bandwidth.

2. Description of the Prior Art

In recent years, as the wireless communication technology develops and expands, higher demands for wireless communication are increased. Since more information is transmitted through wireless network, a wide bandwidth of an antenna for transmitting and receiving wireless signals is necessary. In addition, as regards sizes of communication devices, space for designs is limited, which influences designs of the antenna.

Please refer to FIG. 1, which is a schematic diagram of a slot antenna 10 utilized in a wireless network. The slot antenna 10 includes a substrate 100, a radiator 102, and a signal-feeding segment 104. The substrate 100 includes a front plane and a rear plane. The radiator 102 is set on the front plane of the substrate 100, and the signal-feeding segment 104 is set on the rear plane of the substrate 100. As can be seen in FIG. 1, the radiator 102 is bent to form a slot 106, and a length of the radiator 102 near a side of the slot 106 can be adjusted for generating a desired resonant frequency. A position of the signal-feeding segment 104 is corresponding to the slot 106, and includes a signal-feeding end 108 for receiving signals. When a signal is fed into the signal-feeding end 108, energy is coupled to the radiator 102 via the signal-feeding segment 104, so as to transmit signals.

However, the slot antenna 10 of the prior art occupies a large area, and the bandwidth of the slot antenna 10 is not sufficient, so the slot antenna 10 needs to be improved to fulfill utilization requirements.

### SUMMARY OF THE INVENTION

It is therefore a primary objective of the present invention to provide a slot antenna, to improve shortcomings of the prior art.

An embodiment of the invention discloses a slot antenna, which includes a substrate, a radiator, a signal-feeding segment, a signal-feeding end, a first extension section and a second extension section. The substrate includes a first plane and a second plane. The radiator is set on the first plane of the substrate, and includes a slot. The signal-feeding segment is set in a position on the second plane of the substrate corresponding to the slot. The signal-feeding end is electrically connected to the signal-feeding segment, and is utilized for transmitting signals. The first extension section is set on a first side of the signal-feeding segment on the second plane of the substrate, and is utilized for increasing a bandwidth of the slot antenna. The second extension section is set on a second side of the signal-feeding segment on the second plane of the substrate, and is utilized for increasing the bandwidth of the slot antenna.

An embodiment of the invention further discloses a slot antenna, which includes a substrate, a radiator, a signal-feeding segment, and a signal-feeding end. The substrate includes a first plane and a second plane. The radiator is set on the first plane of the substrate, and includes a slot. The signal-feeding segment is set in a position on the second plane of the substrate corresponding to the slot, and is bend extension shaped. The signal-feeding end is electrically connected to the signal-feeding segment, and is utilized for transmitting signals.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a slot antenna according to the prior art.

FIG. 2 is a schematic diagram of a slot antenna according to an embodiment of the invention.

FIG. 3 is a schematic diagram of voltage standing wave ratios of slot antennas shown in FIG. 1 and FIG. 2.

FIG. 4˜16 are schematic diagrams of slot antennas according to embodiments of the invention.

FIG. 17 is a schematic diagram of a slot antenna bent into a three dimensional shape according to an embodiment of the invention.

### DETAILED DESCRIPTION

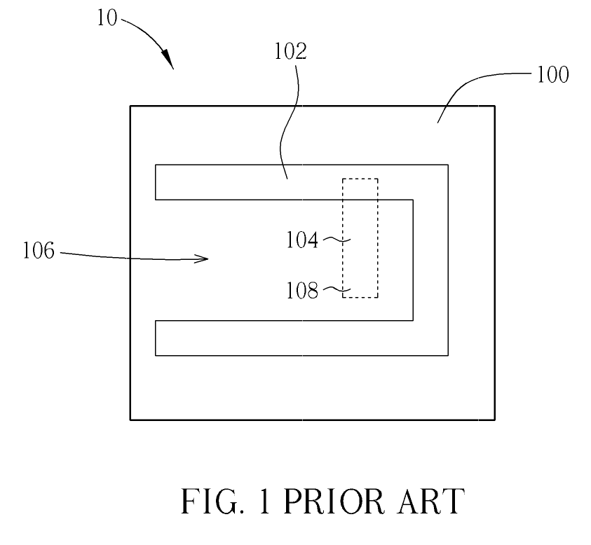

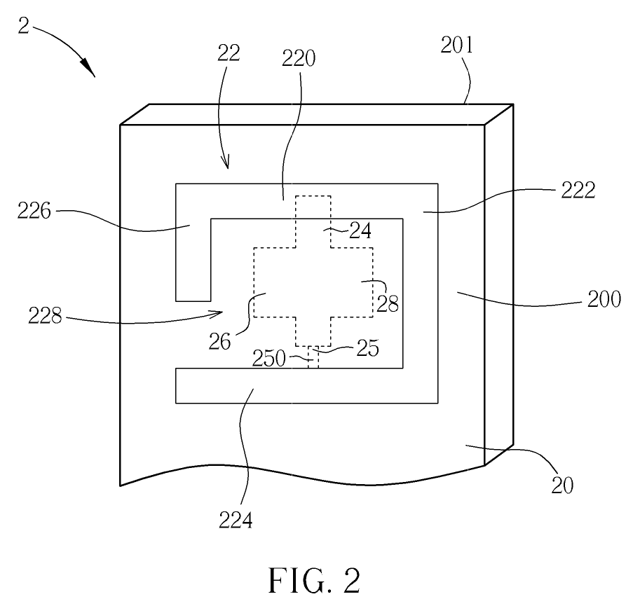

Please refer to FIG. 2, which is a schematic diagram of a slot antenna 2 according to an embodiment of the invention. A main operating frequency band of the slot antenna 2 is 2300 MHz˜2700 MHz, and the slot antenna 2 includes a substrate 20, a radiator 22, a signal-feeding segment 24, a signal-feeding end 25, a first extension section 26, and a second extension section 28. The substrate 20 includes a first plane 200 and a second plane 201 opposite to the first plane 200, and can be made of FR4 or other material. The radiator 22 is set on the first plane 200 of the substrate 20, and includes a first radiating segment 220, a second radiating segment 222, a third radiating segment 224, and a fourth radiating segment 226. As can be seen in FIG. 2, the first radiating segment 220, the second radiating segment 222, the third radiating segment 224, and the fourth radiating segment 226 are respectively perpendicular to an adjacent radiating segment, which means that the fourth radiating segment 226 is perpendicular to the first radiating segment 220, the first radiating segment 220 is perpendicular to the second radiating segment 222, and the second radiating segment 222 is perpendicular to the third radiating segment 224. In other words, these four radiating segments form a slot 228. A length of the slot 228 is about a quarter of a wavelength corresponding to the frequency band (2300 MHz˜2700 MHz), namely around 31.3 millimeter. In addition, the third radiating segment 224 is electrically connected to a ground, and the ground is preferably made of copper foil. Note that, besides utilizing the third radiating segment 224 electrically connected to a ground, the first radiating segment 220 or the second radiating segment 222 can be electrically connected to a ground also. These three implement methods are included in the invention. In addition, a function of the fourth radiating segment 226 is to reduce an area occupied by the slot antenna 2. Compare with the prior art shown in FIG. 1, the area occupied by the slot antenna 2 can be reduced about 26% due to a bend of the fourth radiating segment 226.

In the slot antenna 2, the signal-feeding segment 24 is set on the second plane 201 of the substrate 20, and approximately corresponding to a center of the slot 228. The signal-feeding segment 24 is rectangle shaped, and is parallel to the second radiating segment 222. An end of the signal-feeding segment 24 is electrically connected to the signal-feeding end 25, and used for receiving signals transmitted from a signal cable 250. The first extension section 26 and the second extension section 28 are set on the second plane 201 of the substrate 20, electrically connected to the signal-feeding segment 24, and extended to sides of the signal-feeding segment 24, for increasing the bandwidth of the slot antenna 2.

As can be seen, the invention reduces the area occupied by the slot antenna 2 via the fourth radiating segment 226, and increases the frequency band of the slot antenna 2 via the first extension section 26 and the second extension section 28.

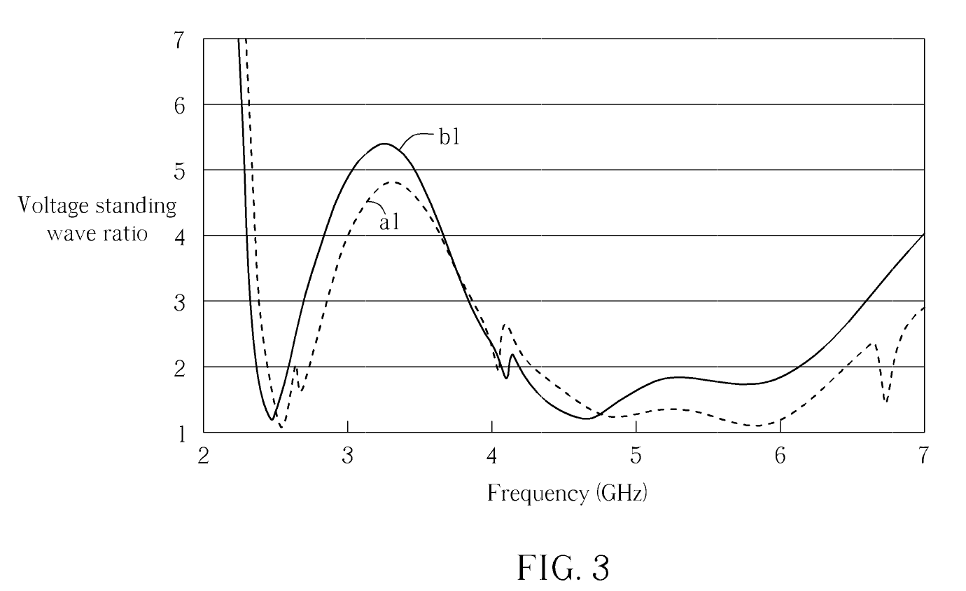

Please refer to FIG. 3, which is a schematic diagram of voltage standing wave ratios (VSWR) of the slot antenna 10 and the slot antenna 2 respectively shown in FIG. 1 and FIG. 2. A curve a1 represents VSWR of the slot antenna 2 corresponding to frequencies, and a curve b1 represents VSWR of the slot antenna 10 corresponding to frequencies. As can be seen, between 2 GHz˜3 GHz, the curve a1 is wider than the curve b1 when VSWR is small than 2. In comparison, the frequency band of the slot antenna 2 of the invention is wider than the prior art shown in FIG. 1 because the slot antenna 2 of the invention adds the first extension section 26 and the second extension section 28, to realize the function of increasing the frequency band.

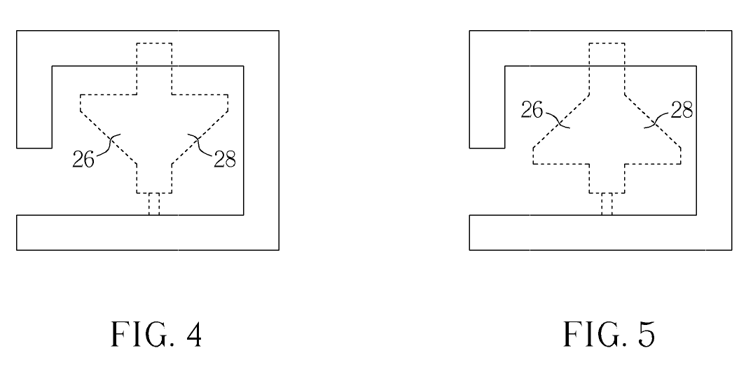

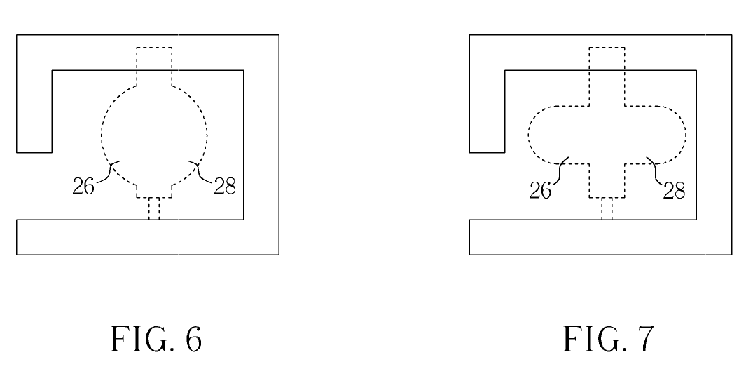

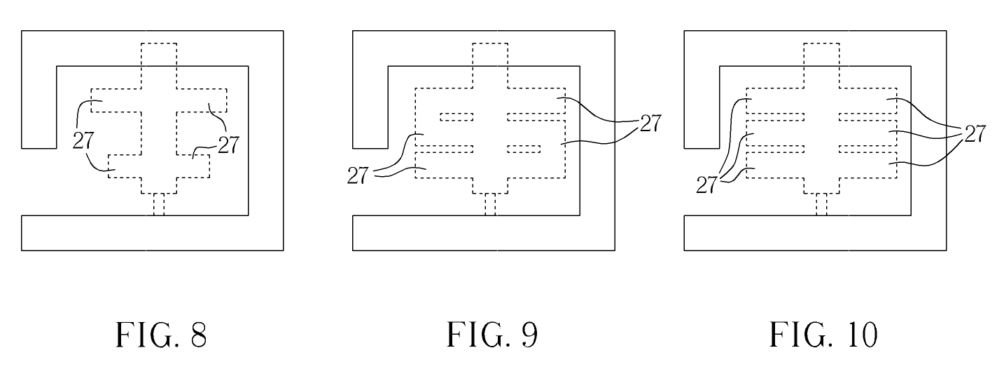

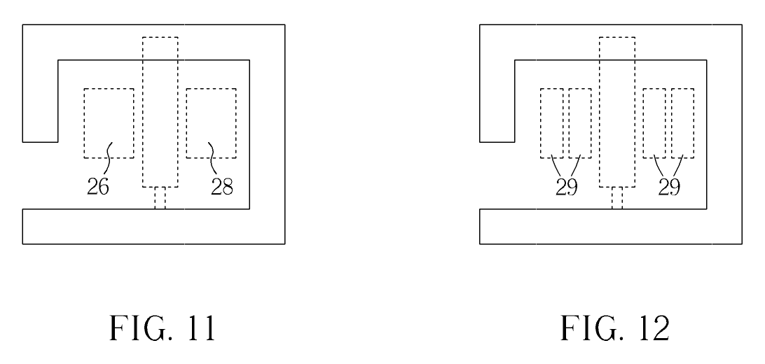

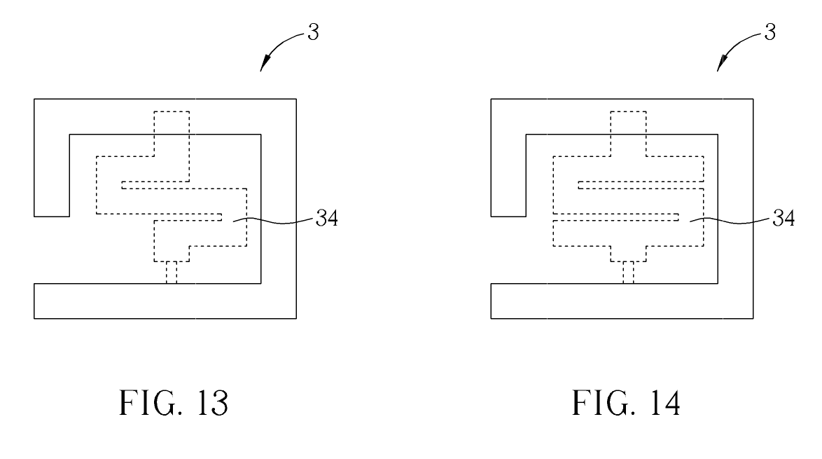

Note that, the first extension section 26 and the second extension section 28 are rectangle shaped in FIG. 2. In practical, the first extension section 26 and the second extension section 28 can be other shapes, such as triangle (refer to FIGS. 4 and 5), semi-circle (refer to FIG. 6), or semi-ellipse (refer to FIG. 7), and sizes of the first extension section 26 and the second extension section 28 can be designed differently. In addition, the number of the first extension section 26 or the second extension section 28 is not limited to a certain value, and can be realized by a plurality of extension sections 27 shown in FIGS. 8, 9, and 10. Moreover, the first extension section 26 and the second extension section 28 are separated with the signal-feeding segment 24 by a preset distance as shown in FIG. 11. Certainly, a plurality of extension sections 29 can be added in this situation as shown in FIG. 12. Designs as mentioned above can increase the frequency band of the slot antenna 2, and are not limited herein.

In addition, please refer to FIG. 13, which is a schematic diagram of a slot antenna 3 according to an embodiment of the invention. A structure of the slot antenna 3 shown in FIG. 13 is similar to the slot antenna 2 shown in FIG. 2. The only difference is that the slot antenna 3 does not utilize the first extension section 26 and the second extension section 28 as shown in FIG. 2, but utilizes a bent extension signal-feeding segment 34 for increasing the frequency band of the slot antenna 3. Similarly, a shape of the signal-feeding segment 34 can be varied, as shown in FIG. 14, which also can realize the goal of increasing the frequency band of the slot antenna 3.

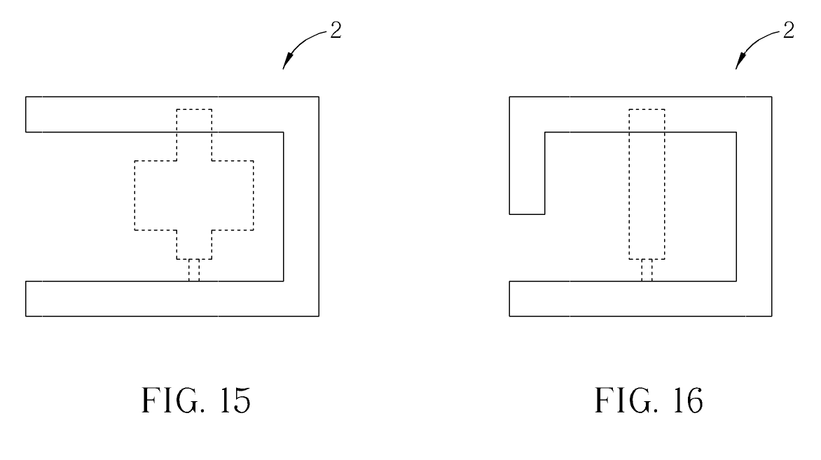

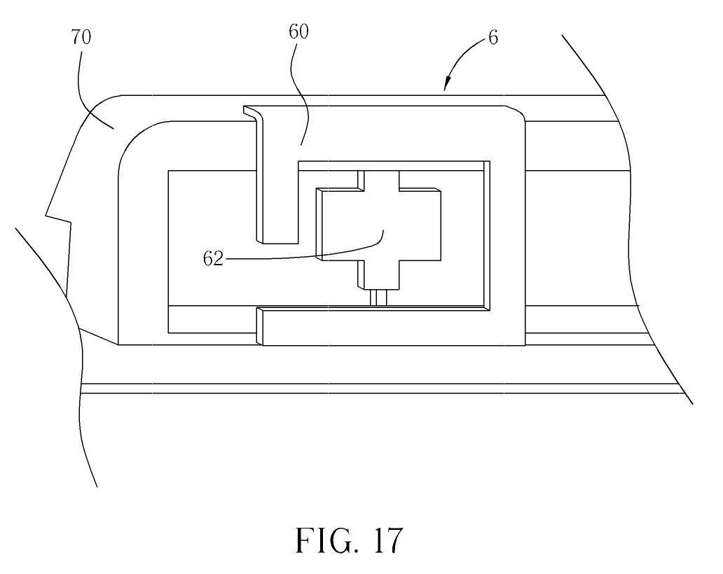

Note that, the slot antenna 2 shown in FIG. 2 can eliminate the fourth radiating segment 226, and increase the lengths of other radiating segments (as shown in FIG. 15), or eliminate the first extension section 26 and the second extension section 28 (as shown in FIG. 16). In addition, the abovementioned slot antenna 2 and 3 can be made of micro-strip lines or some harder materials, and can be bent into a three dimensional shape, for increasing varieties and flexibilities of the design. For example, please refer to FIG. 17, a slot antenna 6 is bent into a three dimensional shape, and installed in a holder 70 of an electrical device (such as a notebook). The holder 70 can separate a radiator 60 of the slot antenna 6 and a signal-feeding segment 62. Therefore, when the slot antenna 6 is bent into a three dimensional shape, the area occupied by the slot antenna 6 is smaller, and can be used in a smaller electrical device.

In conclusion, the slot antenna of the invention utilizes the fourth radiating segment for reducing the area occupied by the antenna, and utilizes the first extension section and the second extension section for increasing the frequency band of the antenna, to achieve the goal of the invention.

Those skilled in the art will readily observe that numerous modifications and alterations of the device and method may be made while retaining the teachings of the invention.

What is claimed is:

1. A slot antenna comprising:
a substrate comprising a first plane and a second plane;
a radiator set on the first plane of the substrate, and comprising a slot;
a signal-feeding segment set in a position on the second plane of the substrate corresponding to the slot;
a signal-feeding end electrically connected to the signal-feeding segment, for transmitting signals;
a first extension section set on a first side of the signal-feeding segment on the second plane of the substrate, for increasing a bandwidth of the slot antenna; and
a second extension section set on a second side of the signal-feeding segment on the second plane of the substrate, for increasing the bandwidth of the slot antenna.

2. The slot antenna of claim 1, wherein the first extension section and the second extension section are rectangle shaped.

3. The slot antenna of claim 1, wherein the first extension section and the second extension section are triangle shaped.

4. The slot antenna of claim 1, wherein the first extension section and the second extension section are semi-circle shaped.

5. The slot antenna of claim 1, wherein the first extension section and the second extension section are semi-ellipse shaped.

6. The slot antenna of claim 1, wherein the first side and the second side are in opposition.

7. The slot antenna of claim 1, wherein the first extension section and the second extension section are electrically connected to the signal-feeding segment.

8. The slot antenna of claim 1, wherein the first extension section and the second extension section are separated with the signal-feeding segment by a preset distance.

9. The slot antenna of claim 1, wherein the radiator comprising:
a first radiating segment;
a second radiating segment electrically connected to the first radiating segment; and
a third radiating segment electrically connected to the second radiating segment.

10. The slot antenna of claim 9, wherein the second radiating segment is perpendicular to the first radiating segment and the third radiating segment is perpendicular to the second radiating segment.

11. The slot antenna of claim 9 further comprising a fourth radiating segment electrically connected to an end of the first radiating segment, which is not electrically connected to the second radiating segment.

12. The slot antenna of claim 11, wherein the fourth radiating segment is parallel to the second radiating segment.

13. The slot antenna of claim 9, wherein the first radiating segment, the second radiating segment, or the third radiating segment is electrically connected to a ground.

14. A slot antenna comprising:
a substrate comprising a first plane and a second plane;
a radiator set on the first plane of the substrate, and comprising a slot;
a signal-feeding segment set in a position on the second plane of the substrate corresponding to the slot, and being bend extension shaped; and
a signal-feeding end electrically connected to the signal-feeding segment, for transmitting signals.

15. The slot antenna of claim 14, wherein the radiator comprising:
a first radiating segment;
a second radiating segment electrically connected to the first radiating segment; and
a third radiating segment electrically connected to the second radiating segment.

16. The slot antenna of claim 15, wherein the second radiating segment is perpendicular to the first radiating segment and the third radiating segment is perpendicular to the second radiating segment.

17. The slot antenna of claim 15 further comprising a fourth radiating segment electrically connected to an end of the first radiating segment, which is not electrically connected to the second radiating segment.

18. The slot antenna of claim 17, wherein the fourth radiating segment is parallel to the second radiating segment.

19. The slot antenna of claim 15, wherein the first radiating segment, the second radiating segment, or the third radiating segment is electrically connected to a ground.
